(19) United States
(12) Patent Application Publication
(10) Pub. No.: US 2010/0163081 A1
(43) Pub. Date: Jul. 1, 2010

(54) CLEANING APPARATUS

(76) Inventor: Mugihei IKEMIZU, Osaka (JP)

Correspondence Address: BIRCH STEWART KOLASCH & BIRCH, PO BOX 747, FALLS CHURCH, VA, 22040-0747, US

(21) Appl. No.: 12/628,328

(22) Filed: Dec. 1, 2009

(30) Foreign Application Priority Data
Dec. 25, 2008 (JP) 2008-329186

(51) Int. Cl. B08B 3/00

(52) U.S. Cl. 134/115 R

(57) ABSTRACT

Provided is a cleaning apparatus which has a simple configuration and is capable of efficiently cleaning a to-be-cleaned object. A washing machine comprises: a first carbon dioxide supply unit, which includes a carbon dioxide cylinder, a three-way valve, a pump, and an on-off valve, for supplying carbon dioxide in a gas state to a cleaning liquid containing water and a surface-active agent; a pressurization unit for pressuring the cleaning liquid so as to dissolve, in the cleaning liquid, at least a part of the carbon dioxide in the gas state; a decompression unit for decompressing the pressurized cleaning liquid and thereby causing the carbon dioxide dissolved in the cleaning liquid to bubble; and a washing tank for cleaning a fabric structure by the cleaning liquid containing the decompressed and thereby bubbling carbon dioxide.

### BACKGROUND OF THE INVENTION

1. Field of the Invention

The present invention relates to a cleaning apparatus.

2. Description of the Related Art

Conventionally, it has been proposed that a to-be-cleaned object is cleaned by utilizing an impact force obtained when bubbles are generated by pressurizing a fluid used for cleaning and thereafter, abruptly decompressing it.

For example, in a cleaning method disclosed in Japanese Patent Application Laid-Open Publication No. 8-290128, a to-be-cleaned object is cleaned through forcedly exfoliating and forcedly dissolving a contaminant by utilizing flowing action and bubbling action obtained when intense agitation and a large amount of bubbles are generated on a surface of the contaminant by rapidly decompressing supercritical and subcritical fluids with an entrainer added.

In this way, the forced exfoliation caused by the generation of the bubbles enables a removal of solid soil such as particles.

As a washing machine utilizing the bubbles, Japanese Patent Application Laid-Open Publication No. 59-232581 discloses a household washing machine in which pressurized air is supplied into water in a washing tank from a lower part of the washing tank and the pressurized air on a surface of the water in the washing tank is caused to periodically discharge a pressure. In this washing machine, upon discharging the pressure in the washing tank, air bubbles are blown up from a bottom part of the washing tank and laundry is efficiently moved, thereby avoiding a nonuniform soil removal. In addition, large and small bubbles included in fabric of the laundry are contracted and expanded by periodically repeating the pressurization and the pressure discharge in the washing tank, thereby promoting a dissolution of the soil.

However, in order to generate a large amount of the bubbles by rapidly decompressing the supercritical fluid or the subcritical fluid, it is required to pressurize the supercritical fluid or the subcritical fluid so as to be at an extremely high pressure before the decompression. Therefore, it requires time for the pressurization and the decompression. In addition, a container for pressuring the fluid in a supercritical or subcritical state and a pipe through which the fluid in the supercritical or subcritical state circulates are required to have a pressure resistance.

### SUMMARY OF THE INVENTION

Therefore, an object of the present invention is to provide a cleaning apparatus which has a simple configuration and is capable of efficiently cleaning a to-be-cleaned object.

A cleaning apparatus according to the present invention comprises: a first carbon dioxide supply unit, a pressurization unit, a decompression unit, and a washing tank. The first carbon dioxide supply unit supplies carbon dioxide in a gas state to a cleaning liquid containing water and a surface-active agent. The pressurization unit pressurizes the cleaning liquid having the carbon dioxide in the gas state supplied thereto so as to cause at least a part of the carbon dioxide in the gas state to be dissolved in the cleaning liquid, the carbon dioxide supplied by the first carbon dioxide supply unit. The decompression unit causes the carbon dioxide dissolved in the cleaning liquid to bubble by decompressing the cleaning liquid pressurized by the pressurization unit. The washing tank cleans a to-be-cleaned object by the cleaning liquid containing the carbon dioxide decompressed by the decompression unit and thereby caused to be bubbling.

The carbon dioxide in the gas state is supplied to the cleaning liquid containing the water and the surface-active agent by the first carbon dioxide supply unit, and the pressurization is performed by the pressurization unit, thereby causing said at least a part of the carbon dioxide in the gas state to be dissolved in the cleaning liquid.

The cleaning liquid in which the carbon dioxide has been dissolved is decompressed by the decompression unit, thereby causing the carbon dioxide dissolved in the cleaning liquid to bubble.

By cleaning the to-be-cleaned object by the cleaning liquid containing the bubbling carbon dioxide, the to-be-cleaned object can be effectively cleaned, as compared with a case where the to-be-cleaned object is cleaned by only a cleaning liquid.

In addition, in a case where the carbon dioxide in the gas state is pressurized to be dissolved in the cleaning liquid and thereafter, is decompressed to be caused to bubble, sufficient bubbling can be obtained even when a pressure exerted upon the pressurization is low, as compared with a case where a fluid in the supercritical or subcritical state is decompressed and pressurized to be caused to bubble.

Therefore, time required for the pressurization by the pressurization unit and the decompression by the decompression unit can be shortened, as compared with the case where the fluid in the supercritical or subcritical state is used to be caused to bubble. In addition, a high-performance pressurization pump is not required to be provided.

In addition, it is not required to enhance, for example, a pressure resistance of the container for pressurizing the cleaning liquid to which the carbon dioxide in the gas state has been supplied and pressure resistances of the pipes through which the cleaning liquid circulates, as compared with the case where the fluid in the supercritical or subcritical state is used to be caused to bubble.

In addition, since a volume of the cleaning liquid is increased by causing the cleaning liquid to bubble, even when an amount of the cleaning liquid is small, the to-be-cleaned object can be caused to contact the cleaning liquid, thereby allowing the to-be-cleaned object to be cleaned. Since the to-be-cleaned object can be cleaned by using a very small amount of the water, an amount of the water used in the washing machine can be saved. In addition, since the amount of the water used for cleaning the to-be-cleaned object is small, dewatering and drying can be easily performed after having cleaned the to-be-cleaned object.

In addition, the carbon dioxide is easily dissolved in the water, as compared with other gases contained in the air, that is, nitrogen and oxygen. Therefore, by using the carbon dioxide as a gas to be dissolved in the cleaning liquid, an increased amount of the gas can be dissolved, as compared with a case where the nitrogen, the oxygen, or the air is dissolved in the cleaning liquid. As mentioned above, by dissolving the increased amount of the gas therein, an increased amount of the bubbles can be generated when the pressurized cleaning liquid is decompressed.

In this way, the cleaning apparatus which has the simple configuration and is capable of efficiently cleaning the to-be-cleaned object can be provided.

It is preferable that the cleaning apparatus according to the present invention comprises a preprocessing tank, the first carbon dioxide supply unit supplies the carbon dioxide in the gas state to the cleaning liquid containing the water and the surface-active agent, the cleaning liquid contained in the preprocessing tank, and the pressurization unit pressurizes and the decompression unit decompresses, in the preprocessing tank, the cleaning liquid having the carbon dioxide supplied thereto.

Upon the bubbling of the carbon dioxide dissolved in the cleaning liquid, there may be a case where if the carbon dioxide bubbles on a surface of the to-be-cleaned object to which the surface-active agent has adhered, a part of the surface-active agent, which has adhered to the to-be-cleaned object, remains thereon as it is and the to-be-cleaned object is cleaned in a nonuniform manner.

Therefore, in the preprocessing tank, the carbon dioxide in the gas state is supplied to the cleaning liquid and is pressurized and decompressed. At least a part of the carbon dioxide in the gas state is dissolved in the cleaning liquid in the preprocessing tank and thereafter, bubbles.

In this way, the cleaning liquid caused to be bubbling in the preprocessing tank and contains the carbon dioxide can be used for cleaning the to-be-cleaned object, thereby reducing the nonuniformity of the cleaning of the to-be-cleaned object.

It is preferable that in the cleaning apparatus according to the present invention, the pressurization unit pressurizes the cleaning liquid having the carbon dioxide supplied thereto such that a pressure of the cleaning comes to greater than or equal to 0.4 MPa.

Through the pressurization in such a manner, the carbon dioxide can be caused to bubble in an ensured manner.

It is preferable that the cleaning apparatus according to the present invention comprises a second carbon dioxide supply unit and a controller. The second carbon dioxide supply unit supplies carbon dioxide in a supercritical or subcritical state to the to-be-cleaned object contained in the washing tank. The controller controls the first carbon dioxide supply unit, the pressurization unit, the decompression unit, and the second carbon dioxide supply unit. It is preferable that the controller controls the first carbon dioxide supply unit, the pressurization unit, the decompression unit, and the second carbon dioxide supply unit such that a first cleaning step in which the to-be-cleaned object is cleaned in the washing tank by the cleaning liquid containing the carbon dioxide having bubbled is performed and after the first cleaning step, a second cleaning step in which the carbon dioxide in the supercritical or subcritical state is supplied to the washing tank and the to-be-cleaned object is cleaned is performed.

By using the cleaning liquid containing the water and the surface-active agent, water-soluble soil and soil caused by proteins can be removed well from the to-be-cleaned object. In addition, by using the cleaning liquid containing the bubbling carbon dioxide, soil which cannot be removed only by a cleaning liquid not containing the bubbling carbon dioxide can be easily removed.

However, there may be a case where oil-soluble soil is hardly removed by a cleaning liquid or the cleaning liquid containing the bubbling carbon dioxide.

Therefore, it is preferable that the cleaning apparatus comprises the second carbon dioxide supply unit for supplying the carbon dioxide in the supercritical or subcritical state to the washing tank and the controller, and the controller controls the first carbon dioxide supply unit, the pressurization unit, the decompression unit, and the second carbon dioxide supply unit such that the first cleaning step and the second cleaning step are performed.

First, in the first cleaning step, the to-be-cleaned object is cleaned by the cleaning liquid containing the bubbling carbon dioxide in the washing tank, whereby the water-soluble soil and the soil caused by the proteins are removed from the to-be-cleaned object.

Next, in the second cleaning step, the carbon dioxide in the supercritical or subcritical state is supplied to the washing tank and the to-be-cleaned object is cleaned, whereby the oil-soluble soil is removed from the to-be-cleaned object.

In this way, the soil which is hardly removed from the to-be-cleaned object only by the cleaning liquid containing the bubbling carbon dioxide can be removed. In addition, an additive such as the surface-active agent can be efficiently applied to the to-be-cleaned object together with the carbon dioxide in the supercritical or subcritical state.

As described above, according to the present invention, the cleaning apparatus which has the simple configuration and is capable of efficiently cleaning the to-be-cleaned object can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating a whole of a washing machine as a first embodiment according to the present invention; and

FIG. 2 is a schematic diagram illustrating a whole of a washing machine as a second embodiment according to the present invention.

### DESCRIPTION OF THE PREFERRED EMBODIMENTS

Hereinafter, embodiments of the present invention will be described with reference to drawings.

### First Embodiment

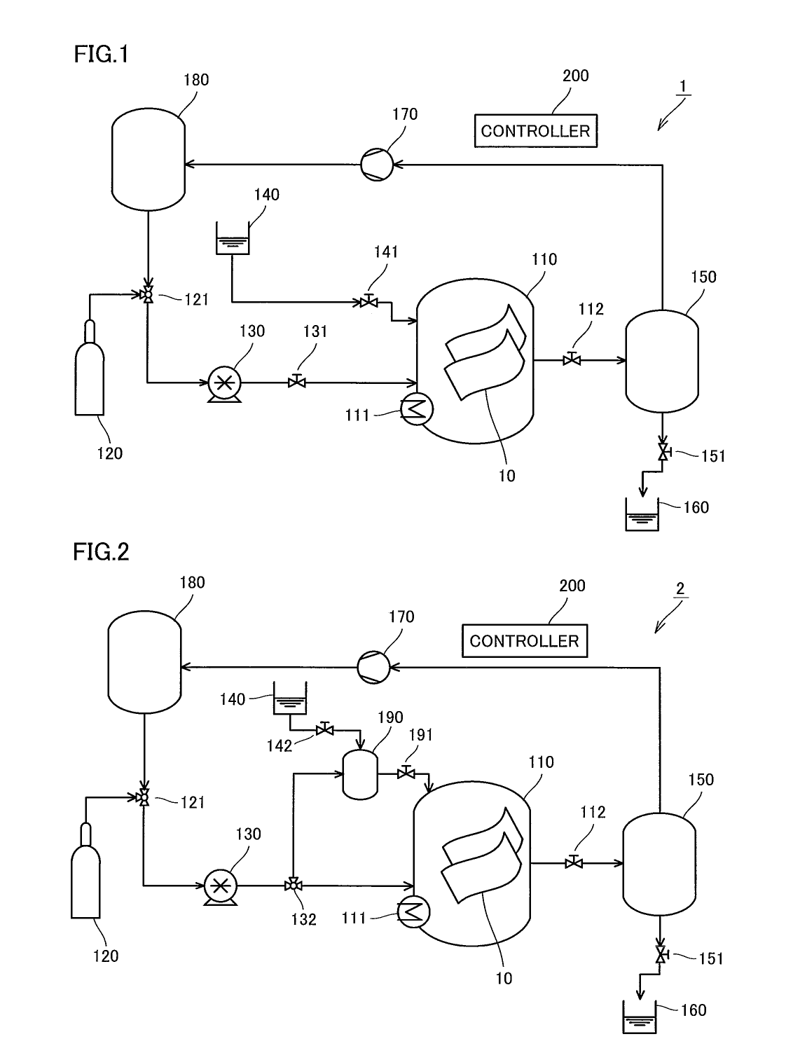

As shown in FIG. 1, a washing machine 1 as a cleaning apparatus mainly comprises: a washing tank 110, a carbon dioxide cylinder 120, a pump 130, a detergent input unit 140, a gas-liquid separation tank 150, a soil receptacle 160, a compressor 170, a liquid carbon dioxide tank 180, and a controller 200. In the washing tank 110, as a to-be-cleaned object, a fabric structure 10 such as clothing is contained. The washing tank 110 is provided with a temperature controller 111. As the temperature controller 111, for example, a heater is used. In addition, in the washing tank 110, an agitation unit (not shown) for causing the fabric structure 10 contained in the washing tank 110 to contact the fluid is placed.

A unit of the pump 130, an on-off valve 131, and an on-off valve 112 is one example of a pressurization unit. A unit of the on-off valve 112 and the compressor 170 is one example of a decompression unit. A unit of the carbon dioxide cylinder 120, the liquid carbon dioxide tank 180, the three-way valve 121, the pump 130, and the on-off valve 131 is one example of a first carbon dioxide supply unit. A unit of the liquid carbon dioxide tank 180, the three-way valve 121, the pump 130, and the on-off valve 131 is one example of a second carbon dioxide supply unit.

The liquid carbon dioxide tank 180, the carbon dioxide cylinder 120, and the pump 130 are connected by a pipe in which the three-way valve 121 is placed. The pump 130 and the washing tank 110 are connected by a pipe in which the on-off valve 131 is placed. In a pipe by which the washing tank 110 and the detergent input unit 140 are connected, an on-off valve 141 is placed. In a pipe by which the washing tank 110 and the gas-liquid separation tank 150 are connected, the on-off valve 112 is placed. In a pipe for discharging soil from the gas-liquid separation tank 150 to the soil receptacle 160, an on-off valve 151 is placed. The valves placed in the pipes are appropriately opened and closed. Opening and closing of the valves are performed by the controller 200 as described later.

In this embodiment, carbon dioxide in a liquid state is pooled in the carbon dioxide cylinder 120. The carbon dioxide cylinder 120 may be a cylinder which is filled with carbon dioxide in a gas state so as to be at a pressure greater than or equal to an atmospheric pressure.

The temperature controller 111 adjusts a temperature inside the washing tank 110. The pump 130 sends the carbon dioxide in the carbon dioxide cylinder 120 or the liquid carbon dioxide tank 180 to the washing tank 110. The compressor 170 compresses and liquefies the carbon dioxide in the gas state, discharged from the gas-liquid separation tank 150, and sends it to the liquid carbon dioxide tank 180.

The controller 200 controls driving of the pump 130, the compressor 170, and the temperature controller 111. In addition, the controller 200 controls the opening and closing of the on-off valve 112, the on-off valve 131, the on-off valve 141, and the on-off valve 151 and controls switching of the three-way valve 121.

Operations of the cleaning apparatus of the first embodiment, configured as described above, will be described.

First, a user causes the fabric structure 10 to be contained in the washing tank 110. In the detergent input unit 140, a cleaning liquid containing a surface-active agent and water is contained. The user operates an operation unit (not shown) of the washing machine 1 and causes the washing machine 1 to start washing.

In the washing machine 1, first, a first cleaning step is performed.

The controller 200 controls the on-off valve 141 such that the on-off valve 141 is opened for a predetermined period of time. When the on-off valve 141 is opened, the cleaning liquid is supplied from the detergent input unit 140 to the washing tank 110. An amount of the cleaning liquid, which allows the fabric structure 10 not to be immersed therein, is inputted.

Next, the controller 200 switches the three-way valve 121 and opens the on-off valve 131 so as to allow the carbon dioxide in the gas state to be supplied from the carbon dioxide cylinder 120 to the washing tank 110.

In the carbon dioxide cylinder 120, the carbon dioxide in a highly-pressurized state is contained. For example, an internal pressure of the carbon dioxide cylinder 120, which is generally used and filled with the carbon dioxide in the liquid state, is approximately 4 MPa through 7 MPa in the vicinity of ordinary temperatures. Therefore, even when the pump 130 is not driven, the carbon dioxide can be supplied into the washing tank 110.

In addition, by causing the controller 200 to control the three-way valve 121 and the pump 130, the carbon dioxide may be supplied from the liquid carbon dioxide tank 180 to the washing tank 110.

The controller 200 supplies the carbon dioxide into the washing tank 110 such that a pressure inside the washing tank 110 comes to 0.4 MPa (gauge pressure). As described above, the carbon dioxide in the gas state is supplied into the washing tank 110. A pressure inside the washing tank 110 may be controlled by detecting a pressure inside the washing tank 110. In addition, a pressure inside the washing tank 110 may be controlled in accordance with time at which the three-way valve 121 is switched and time at which the on-off valve 131 is opened so as to supply the carbon dioxide into the washing tank 110.

The carbon dioxide in the gas state is dissolved in the water contained in the cleaning liquid. The carbon dioxide in the gas state is very easily dissolved in the water, as compared with other gases in the air, that is, nitrogen and oxygen. In addition, by increasing a pressure inside the washing tank 110, a dissolved amount of the carbon dioxide in the gas state with respect to the water can be increased.

The controller 200 supplies the carbon dioxide into the washing tank 110 by controlling the three-way valve 121, the pump 130, the on-off valve 131, and the on-off valve 112 such that the pressure inside the washing tank 110 comes to 0.4 MPa, whereby in the washing tank 110, at least a part of the carbon dioxide in the gas state is dissolved in the cleaning liquid.

Next, the controller 200 opens the on-off valve 112 and drives the compressor 170, whereby a pressure inside the washing tank 110 is decompressed so as to come to the vicinity of 0 MPa (gauge pressure). The decompression inside the washing tank 110 may be performed by opening an inside of the washing tank 110 such that a pressure inside the washing tank 110 comes to an atmospheric pressure.

Since upon the decompression, a reduction in a temperature is small, as compared with a case where decompression is performed so as to bubble the carbon dioxide in the supercritical or subcritical state, it is not required to heat the carbon dioxide with a heating unit such as a heater in order to prevent the carbon dioxide from being rendered in a dry-ice state.

For example, when carbon dioxide in a supercritical state at 10 MPa and 50° C. is decompressed so as to have a ordinary pressure, theoretically, a temperature under a thermal insulation condition is reduced so as to come to −88° C. In a case where the temperature is reduced as mentioned above, the carbon dioxide is rendered in the dry-ice state, whereby it is likely that clogging of the pipes occurs and the fabric structure 10 is adversely affected. Therefore, it is required to perform decompression by taking time or to perform decompression while heating is being performed.

However, even when the carbon dioxide in the gas state at 0.4 MPa and 50° C. is decompressed so as to have the ordinary pressure, a temperature is reduced so as to come to merely 7° C. In reality, even if the carbon dioxide in the gas state at 0.4 MPa and 25° C. is instantaneously decompressed, a temperature is reduced so as to come to merely approximately 15° C. due to an influence of a thermal capacity of a container.

When the inside of the washing tank 110 is decompressed, an amount of the carbon dioxide, which can be dissolved in the cleaning liquid, is decreased. Therefore, bubbles of the carbon dioxide are generated in the cleaning liquid. The bubbles of the carbon dioxide ascend toward a liquid surface of the cleaning liquid. Since the cleaning liquid contains the surface-active agent, when the bubbles of the carbon dioxide are generated in the cleaning liquid and the bubbles of the carbon dioxide ascend, the cleaning liquid intensely bubbles.

Inside the washing tank 110, the amount of the cleaning liquid, which allows the fabric structure 10 not to be immersed therein, is contained. However, when the cleaning liquid bubbles, a volume of the cleaning liquid in the washing tank 110 is increased and the fabric structure 10 contacts the bubbling cleaning liquid. When the fabric structure 10 contacts the cleaning liquid, the fabric structure 10 is cleaned. In addition, when the bubbles in the bubbling cleaning liquid disappear, components of the cleaning liquid are released into the gas and adhere to the fabric structure 10. By removing from the fabric structure 10 the cleaning liquid itself which has taken in the soil of the fabric structure 10, the soil is removed from the fabric structure 10. As for a method for removing the cleaning liquid, in a case where an amount of the soil is small and an amount of the cleaning liquid is sufficiently large, the cleaning liquid can be removed by dripping the cleaning liquid as a liquid from the fabric structure 10 or dewatering may be performed through centrifugal dehydration or the like.

In addition, the cleaning liquid may be caused to contain a component, such as a bleaching component, which decomposes the soil, whereby the soil may be decomposed. In this case, by causing the components of the cleaning liquid to adhere to the fabric structure 10, the soil of the fabric structure 10 is removed.

However, it is most preferable that the later-described second cleaning step is performed.

In this way, in the first cleaning step, the fabric structure 10 is cleaned by the cleaning liquid containing the bubbling carbon dioxide.

As described above, after the fabric structure 10 has been cleaned by the cleaning liquid containing the bubbling carbon dioxide in the first cleaning step, the second cleaning step is performed in the washing machine 1.

In the second cleaning step, the controller 200 controls the three-way valve 121 and the on-off valve 131 so as to supply the carbon dioxide again from the carbon dioxide cylinder 120 to the washing tank 110. In addition, the controller 200 controls the temperature controller 111 of the washing tank 110 so as to render the carbon dioxide in the washing tank 110 to be in the supercritical or subcritical state. In addition, by driving the agitation unit, the fabric structure 10 is agitated.

In this way, in the second cleaning step, the fabric structure 10 is cleaned by the carbon dioxide in the supercritical or subcritical state.

After finishing the second cleaning step, the controller 200 controls the on-off valve 112 such that the on-off valve 112 is opened and the fluid inside the washing tank 110 is sent to the gas-liquid separation tank 150.

Inside the gas-liquid separation tank 150, the carbon dioxide in the gas state and components of the soil removed from the fabric structure 10 in liquid and solid states are separated from each other.

The carbon dioxide in the gas state flows from the gas-liquid separation tank 150 to the compressor 170 and is compressed and liquefied by the compressor 170. The carbon dioxide liquefied by the compressor 170 is pooled in the liquid carbon dioxide tank 180. The carbon dioxide pooled in the liquid carbon dioxide tank 180 is reused for cleaning the fabric structure 10.

On the other hand, the liquid components and the solid components, which have been separated from the carbon dioxide in the gas state in the gas-liquid separation tank 150, are discharged to the soil receptacle 160 when the controller 200 controls the on-off valve 151 so as to open the on-off valve 151.

The second cleaning step is performed as described above.

In this way, the first cleaning step in which the fabric structure 10 is cleaned by the cleaning liquid containing the bubbling carbon dioxide is performed and thereafter, the second cleaning step in which the fabric structure 10 is cleaned by the carbon dioxide in the supercritical or subcritical state is performed, thereby allowing the surface-active agent and water remaining in the fabric structure 10 to be removed. In addition, water-soluble soil which can be hardly removed by the carbon dioxide in the supercritical or subcritical state is removed in the first cleaning step and oil-soluble soil which can be hardly removed by a cleaning liquid is removed in the second cleaning step. Through performing the first cleaning step and the second cleaning step, both of the water-soluble soil and the oil-soluble soil can be removed.

In addition, the surface-active agent acts, as an additive for cleaning the fabric structure 10, in an aqueous solution as well as the carbon dioxide in the supercritical or subcritical state. Therefore, when after the first cleaning step, the surface-active agent contained in the cleaning liquid remains in the fabric structure 10, the surface-active agent can enhance a cleaning effect, exhibited by the carbon dioxide in the supercritical or subcritical state, in the second cleaning step.

As an additive (surface-active agent) which acts in such a manner, it is preferable to use a nonionic surface-active agent. This is because an ionic surface-active agent hardly acts in the carbon dioxide. In particular, since a nonionic surface-active agent, such as polyoxyethylene-(4)-lauryl-ether, whose mole number of added ethylene oxide is less than or equal to 10 has a high affinity for the carbon dioxide, the nonionic surface-active agent acts even in the carbon dioxide and also has an affinity for water, thereby allowing a cleaning liquid containing the water to be prepared. Hence, it is preferable to use such a surface-active agent.

In addition, the method, in which the first cleaning step in which the fabric structure 10 is cleaned by the cleaning liquid containing the surface-active agent is performed and thereafter, the second cleaning step in which the fabric structure 10 is cleaned by the carbon dioxide in the supercritical or subcritical state is performed, thereby causing the surface-active agent to act in the carbon dioxide in the supercritical or subcritical state, is easier than other method for adding the surface-active agent to the carbon dioxide in the supercritical or subcritical state and more effective in utilizing the surface-active agent than the other method.

For example, in order to add the surface-active agent to the carbon dioxide in the supercritical or subcritical state at a high pressure, it is required to press the surface-active agent thereinto with a high pressure. Therefore, a pump for adding the surface-active agent to the carbon dioxide is required. On the other hand, the surface-active agent remaining in the fabric structure 10 in the first cleaning step is utilized in the second cleaning step, whereby such a pump is no longer required.

In addition, in a case where the surface-active agent is first added to the washing tank 110 before the carbon dioxide in the supercritical or subcritical state is supplied to the fabric structure 10 in the washing tank 110, the pump for adding the surface-active agent to the carbon dioxide is not required. However, if the surface-active agent is added to the carbon dioxide as mentioned above, the surface-active agent is dispersed in the whole carbon dioxide in the supercritical or subcritical state. Therefore, it may occur that the surface-active agent does not contact the fabric structure 10, thereby causing inefficiency. On the other hand, by performing the first cleaning step in which the fabric structure 10 is cleaned by the cleaning liquid containing the surface-active agent, when the bubbles generated due to the carbon dioxide in the washing tank 110 disappear, the components of the cleaning liquid, such as the surface-active agent, adhere to the fabric structure 10 which is present in the washing tank 110. Therefore, in the second cleaning step performed thereafter, since the surface-active agent has previously adhered to the fabric structure 10, it does not occur that the surface-active agent does not contact the fabric structure 10 and disperses in the carbon dioxide in the supercritical or subcritical state. Accordingly, the fabric structure 10 can be efficiently cleaned.

As described above, the washing machine 1 of the first embodiment comprises: the carbon dioxide cylinder 120, the three-way valve 121, the pump 130, the on-off valve 131, the pressurization unit, the decompression unit, and the washing tank 110. The carbon dioxide cylinder 120, the three-way valve 121, the pump 130, and the on-off valve 131 supply the carbon dioxide in the gas state to the cleaning liquid containing the water and the surface-active agent. The pressurization unit pressurizes the cleaning liquid, to which the carbon dioxide in the gas state has been supplied, so as to dissolve, in the cleaning liquid, at least a part of the carbon dioxide in the gas state, supplied by the carbon dioxide cylinder 120, the three-way valve 121, the pump 130, and the on-off valve 131. The decompression unit decompresses the cleaning liquid pressurized by the pressurization unit, thereby causing the carbon dioxide dissolved in the cleaning liquid to bubble. The washing tank 110 cleans the fabric structure 10 by the cleaning liquid containing the carbon dioxide bubbling due to the decompression by the decompression unit.

The carbon dioxide in the gas state is supplied to the cleaning liquid containing the water and the surface-active agent by the carbon dioxide cylinder 120, the three-way valve 121, the pump 130, and the on-off valve 131, and the pressurization is performed by the pressurization unit, thereby causing said at least a part of the carbon dioxide in the gas state to be dissolved in the cleaning liquid.

The cleaning liquid in which the carbon dioxide has been dissolved is decompressed by the decompression unit, thereby causing the carbon dioxide dissolved in the cleaning liquid to bubble.

By cleaning the fabric structure 10 by the cleaning liquid containing the bubbling carbon dioxide, the fabric structure 10 can be effectively cleaned, as compared with a case where the fabric structure 10 is cleaned by only a cleaning liquid.

In addition, in a case where the carbon dioxide in the gas state is pressurized to be dissolved in the cleaning liquid and thereafter, is decompressed to be caused to bubble, sufficient bubbling can be obtained even when a pressure exerted upon the pressurization is low, as compared with a case where a fluid in the supercritical or subcritical state is decompressed and pressurized to be caused to bubble.

Therefore, time required for the pressurization by the pressurization unit and the decompression by the decompression unit can be shortened, as compared with the case where the fluid in the supercritical or subcritical state is used to be caused to bubble. In addition, a high-performance pressurization pump is not required to be provided.

In addition, it is not required to enhance, for example, a pressure resistance of the container for pressurizing the cleaning liquid to which the carbon dioxide in the gas state has been supplied and pressure resistances of the pipes through which the cleaning liquid circulates, as compared with the case where the fluid in the supercritical or subcritical state is used to be caused to bubble.

In addition, since a volume of the cleaning liquid is increased by causing the cleaning liquid to bubble, even when an amount of the cleaning liquid is small, the fabric structure 10 can be caused to contact the cleaning liquid, thereby allowing the fabric structure 10 to be cleaned. Since the fabric structure 10 can be cleaned by using a very small amount of the water, an amount of the water used in the washing machine 1 can be saved. In addition, since the amount of the water used for cleaning the fabric structure 10 is small, dewatering and drying can be easily performed after having cleaned the fabric structure 10.

In addition, the carbon dioxide is easily dissolved in the water, as compared with the other gases contained in the air, that is, the nitrogen and the oxygen. In general, an amount of a gas dissolved in the water is large under a condition of a high pressure rather than a low pressure. In a case of the carbon dioxide, a difference between an amount of the carbon dioxide dissolved in the water under a condition of a low pressure and an amount of the carbon dioxide dissolved in the water under a condition of a high pressure is large.

Therefore, by using the carbon dioxide as a gas to be dissolved in the cleaning liquid, an amount of the gas which can be dissolved therein can be increased and an amount of the bubbles which can be generated when the pressurized cleaning liquid is decompressed can be increased, as compared with a case where the nitrogen, the oxygen, or the air is dissolved in the cleaning liquid.

In this way, the washing machine 1 which has a simple configuration and is capable of efficiently cleaning the fabric structure 10 can be provided.

In addition, in the washing machine 1 of the first embodiment, the pressurization unit pressurizes the cleaning liquid, to which the carbon dioxide in the gas state has been supplied, at a pressure greater than or equal to 0.4 MPa.

Through the pressurization in such a manner, the carbon dioxide can be caused to bubble in an ensured manner.

In addition, the washing machine 1 of the first embodiment comprises: the liquid carbon dioxide tank 180, the three-way valve 121, the pump 130, the on-off valve 131, and the controller 200. The liquid carbon dioxide tank 180, the three-way valve 121, the pump 130, and the on-off valve 131 supply the carbon dioxide in the supercritical or subcritical state to the fabric structure 10 contained in the washing tank 110. The controller 200 controls the carbon dioxide cylinder 120, the three-way valve 121, the pump 130, the on-off valve 131, the pressurization unit, the decompression unit, the liquid carbon dioxide tank 180, the three-way valve 121, the pump 130, and the on-off valve 131. The controller 200 controls the pressurization unit, the decompression unit, the three-way valve 121, the pump 130, and the on-off valve 131 such that the first cleaning step in which the fabric structure 10 is cleaned by the cleaning liquid containing the bubbling carbon dioxide in the washing tank 110 is performed and after the first cleaning step, the second cleaning step in which the carbon dioxide in the supercritical or subcritical state is supplied to the washing tank 110 and the fabric structure 10 is cleaned is performed.

By using the cleaning liquid containing the water and the surface-active agent, water-soluble soil and soil caused by proteins can be removed well from the fabric structure 10. In addition, by using the cleaning liquid containing the bubbling carbon dioxide, soil which cannot be removed only by a cleaning liquid not containing the bubbling carbon dioxide can be easily removed.

However, there may be a case where oil-soluble soil is hardly removed by a cleaning liquid or the cleaning liquid containing the bubbling carbon dioxide.

Therefore, it is preferable that the washing machine 1 comprises: the liquid carbon dioxide tank 180 for supplying the carbon dioxide in the supercritical or subcritical state to the washing tank 110, the three-way valve 121, the pump 130, the on-off valve 131, and the controller 200, and the controller 200 controls the carbon dioxide cylinder 120, the three-way valve 121, the pump 130, the on-off valve 131, the pressurization unit, the decompression unit, the liquid carbon dioxide tank 180, the three-way valve 121, the pump 130, and the on-off valve 131 such that the first cleaning step and the second cleaning step are performed.

First, in the first cleaning step, the fabric structure 10 is cleaned by the cleaning liquid containing the bubbling carbon dioxide in the washing tank 110, whereby the water-soluble soil and the soil caused by the proteins are removed from the fabric structure 10.

Next, in the second cleaning step, the carbon dioxide in the supercritical or subcritical state is supplied to the washing tank 110 and the fabric structure 10 is cleaned, whereby the oil-soluble soil is removed from the fabric structure 10.

In this way, the soil which is hardly removed from the fabric structure 10 only by the cleaning liquid containing the bubbling carbon dioxide can be removed. In addition, the additive such as the surface-active agent can be efficiently applied to the fabric structure 10 together with the carbon dioxide in the supercritical or subcritical state.

### Second Embodiment

As shown in FIG. 2, a washing machine 2 as a cleaning apparatus is different from the washing machine 1 of the first embodiment in that the washing machine 2 comprises an bubbling container 190 as a preprocessing tank. A detergent input unit 140 is connected to the bubbling container 190 by a pipe in which an on-off valve 142 is placed. The bubbling container 190 is connected to a washing tank 110 by a pipe in which an on-off valve 191 is placed. In a pipe by which a pump 130 and the washing tank 110 are connected, a three-way valve 132 is placed, instead of the on-off valve 131 (FIG. 1). A pipe on a downstream side of the pump 130 is connected by the three-way valve 132 to a pipe connected to the washing tank 110 and a pipe connected to the bubbling container 190.

In the washing machine 2 of the second embodiment, a unit of a carbon dioxide cylinder 120, a liquid carbon dioxide tank 180, a three-way valve 121, the pump 130, and the three-way valve 132 is one example of a first carbon dioxide supply unit. A unit of the three-way valve 132 and the on-off valve 191 is one example of a pressurization unit. The on-off valve 191 is one example of a decompression unit. A unit of the liquid carbon dioxide tank 180, the three-way valve 121, the pump 130, and the three-way valve 132 is one example of a second carbon dioxide supply unit.

Also in the washing machine 2 of the second embodiment, as similarly to the washing machine 1 of the first embodiment, a first cleaning step and a second cleaning step are performed in order.

In the first cleaning step, a controller 200 closes the on-off valve 191 and opens the on-off valve 142 such that a cleaning liquid is supplied from the detergent input unit 140 to the bubbling container 190.

Next, the controller 200 controls the three-way valve 121 and the three-way valve 132 to supply carbon dioxide from the carbon dioxide cylinder 120 to the bubbling container 190, thereby causing a pressure in the bubbling container 190 to come to 0.4 MPa (gauge pressure). When the pressure in the bubbling container 190 has come to 0.4 MPa (gauge pressure), the controller 200 closes the three-way valve 132.

In this way, the carbon dioxide in a gas state contacts the cleaning liquid in the bubbling container 190 and at least a part of the carbon dioxide in the gas state is dissolved in the cleaning liquid.

Next, the controller 200 opens the on-off valve 191. When the on-off valve 191 is opened, an inside of the bubbling container 190 is decompressed. When the inside of the bubbling container 190 is decompressed, the carbon dioxide dissolved in the cleaning liquid bubbles. Since the carbon dioxide bubbles and thereby, a volume of the cleaning liquid is markedly increased, the cleaning liquid in the bubbling container 190 flows into the washing tank 110.

In the washing tank 110, a fabric structure 10 is agitated by an agitation unit (not shown), whereby the cleaning liquid containing the bubbling carbon dioxide can be caused to contact the whole fabric structure 10. In this way, the fabric structure 10 can be cleaned.

Note that the cleaning liquid containing the bubbling carbon dioxide is supplied to an inside of the washing tank 110 from above the washing tank 110, and also in the washing tank 110, as in the washing machine 1 of the first embodiment, the carbon dioxide and the cleaning liquid are pressurized and decompressed, thereby allowing the carbon dioxide to be caused to bubble. In this way, by causing bubbles to act from above and below the fabric structure 10, the bubbles can be caused to evenly contact the whole fabric structure 10.

The other parts of the cleaning steps in the washing machine 2 of the second embodiment are the same as those in the washing machine 1 of the first embodiment.

In the washing machine 2, the bubbling container 190 is connected to the washing tank 110 by a bypass from the three-way valve 132.

In a case where after the cleaning by the cleaning liquid containing the bubbling carbon dioxide has been performed, the second cleaning step is performed, carbon dioxide in a supercritical or subcritical state is supplied to the washing tank 110. If the bubbling container 190 is placed on a channel through which the carbon dioxide in the supercritical or subcritical state flows, it is required to configure the bubbling container 190 and the detergent input unit 140 so as to be resistant to a high pressure of several MPa. However, since it is required to configure the detergent input unit 140 so as to have a mechanism which allows a detergent to be easily inputted externally, for example, by making a configuration thereof which allows easy opening and closing, it is difficult to realize specifications which achieve a high-pressure-resistance. Therefore, by providing the bypass channel, when the carbon dioxide in the supercritical or subcritical state is used, a channel which does not communicate with the bubbling container 190 and the detergent input unit 140 is used; and by avoiding the communication with a side of the bubbling container 190, pressure resistance capabilities which are required of the detergent input unit 140 and the bubbling container 190 can be made low.

As described above, the washing machine 2 of the second embodiment comprises the bubbling container 190; the carbon dioxide cylinder 120, the liquid carbon dioxide tank 180, the three-way valve 121, the pump 130, and the three-way valve 132 supply the carbon dioxide in the gas state to the cleaning liquid contained in the bubbling container 190 and containing the water and the surface-active agent; the three-way valve 132 and the on-off valve 191 pressurize and decompress the cleaning liquid, to which the carbon dioxide has been supplied, in the bubbling container 190.

Upon the bubbling of the carbon dioxide dissolved in the cleaning liquid, there may be a case where if the carbon dioxide bubbles on a surface of the fabric structure 10 to which the surface-active agent has adhered, a part of the surface-active agent, which has adhered to the fabric structure 10, remains thereon as it is and the fabric structure 10 is cleaned in a nonuniform manner.

Therefore, in the bubbling container 190, the carbon dioxide in the gas state is supplied to the cleaning liquid and is pressurized and decompressed. At least a part of the carbon dioxide in the gas state is dissolved in the cleaning liquid in the bubbling container 190 and thereafter, bubbles.

In this way, the cleaning liquid caused to be bubbling in the bubbling container 190 and contains the carbon dioxide can be used for cleaning the fabric structure 10, thereby reducing the nonuniformity of the cleaning of the fabric structure 10.

The other parts of the configuration and effects of the washing machine 2 of the second embodiment are the same as those of the washing machine 1 of the first embodiment.

### Example

In order to ascertain cleaning performance achieved by the cleaning apparatus according to the present invention, the below-described experiment was conducted.

As a to-be-cleaned object, a cloth, manufactured by Yagi Co., Ltd., which has been soiled with a water-soluble contamination was put into the washing tank 110 of the washing machine 1 (FIG. 1) of the first embodiment. The cleaning liquid containing the surface-active agent and the water was contained in the detergent input unit 140, and the first cleaning step in the first embodiment was performed.

The first cleaning step was performed by changing a pressure of the carbon dioxide in the washing tank 110. Cleaning ratios obtained when the carbon dioxide was at respective pressures are shown in Table 1. Measurement of the cleaning ratios was conducted by employing a JIS C9811 method, and the cloth, manufactured by Yagi Co., Ltd., which has been soiled with the water-soluble contamination was used, instead of an artificial contaminated cloth specified in the above-mentioned method.

TABLE 1

| CO₂ Pressure | | Cleaning |
|---|---|---|
| (MPa) | Bubbled/Not Bubbled | Ratio |
| 0.1 | Not Bubbled | 0.00 |
| 0.2 | Not Bubbled | 0.00 |
| 0.3 | Not Bubbled | 0.00 |
| 0.4 | Bubbled | 0.12 |
| 1.3 | Bubbled | 0.27 |
| 6 | Bubbled | 0.27 |
| 20 | Bubbled | 0.35 |

As shown in Table 1, in a case where the carbon dioxide in the washing tank 110 was pressurized such that the pressure thereof came to 0.1 MPa, 0.2 MPa, and 0.3 MPa, when the carbon dioxide was decompressed such that the pressure thereof came to 0 MPa, no bubbles were generated. On the other hand, in a case where the carbon dioxide in the washing tank 110 was pressurized such that the pressure thereof came to 0.4 MPa, 1.3 MPa, 6 MPa, and 20 MPa, when the carbon dioxide was decompressed such that the pressure thereof came to 0 MPa, the cleaning liquid bubbled. In addition, cleaning ratios were 0.12, 0.27, 0.27, 0.35, respectively. In a case where a pressure of the carbon dioxide in the washing tank 110 was less than 0.4 MPa, a cleaning ratio was 0.00.

As described above, it was found that by setting a pressure of the carbon dioxide in the gas state to be greater than or equal to 0.4 MPa, it was made possible to cause the carbon dioxide in the cleaning liquid to bubble in an ensured manner. In addition, it was found that by setting the pressure of the carbon dioxide in the gas state to be greater than or equal to 0.4 MPa, it was made possible to enhance a cleaning ratio.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A cleaning apparatus comprising:
a first carbon dioxide supply unit for supplying carbon dioxide in a gas state to a cleaning liquid containing water and a surface-active agent;
a pressurization unit for pressurizing the cleaning liquid having the carbon dioxide in the gas state supplied thereto so as to cause at least a part of the carbon dioxide in the gas state to be dissolved in the cleaning liquid, the carbon dioxide supplied by the first carbon dioxide supply unit;
a decompression unit for causing the carbon dioxide dissolved in the cleaning liquid to bubble by decompressing the cleaning liquid pressurized by the pressurization unit; and
a washing tank for cleaning a to-be-cleaned object by the cleaning liquid containing the carbon dioxide decompressed by the decompression unit and thereby caused to be bubbling.

2. The cleaning apparatus according to claim 1, comprising
a preprocessing tank, wherein
the first carbon dioxide supply unit supplies the carbon dioxide in the gas state to the cleaning liquid containing the water and the surface-active agent, the cleaning liquid contained in the preprocessing tank, and
the pressurization unit pressurizes and the decompression unit decompresses, in the preprocessing tank, the cleaning liquid having the carbon dioxide supplied thereto.

3. The cleaning apparatus according to claim 1, wherein
the pressurization unit pressurizes the cleaning liquid having the carbon dioxide supplied thereto such that a pressure of the cleaning liquid comes to greater than or equal to 0.4 MPa.

4. The cleaning apparatus according to claim 1, comprising:
a second carbon dioxide supply unit for supplying carbon dioxide in a supercritical or subcritical state to the to-be-cleaned object contained in the washing tank; and
a controller for controlling the first carbon dioxide supply unit, the pressurization unit, the decompression unit, and the second carbon dioxide supply unit, wherein
the controller controls the first carbon dioxide supply unit, the pressurization unit, the decompression unit, and the second carbon dioxide supply unit such that a first cleaning step in which the to-be-cleaned object is cleaned in the washing tank by the cleaning liquid containing the carbon dioxide having bubbled is performed and after the first cleaning step, a second cleaning step in which the carbon dioxide in the supercritical or subcritical state is supplied to the washing tank and the to-be-cleaned object is cleaned is performed.
